(19) United States
(12) Patent Application Publication
(10) Pub. No.: US 2008/0082960 A1
(43) Pub. Date: Apr. 3, 2008

(54) Method and System For Controlling The Release of Data For Multiple-Level Security Systems

(76) Inventors: Monty D. McDougal, Plano, TX (US); William E. Sterns, Wylie, TX (US); Jason E. Ostermann, Plano, TX (US)

Correspondence Address: BAKER BOTTS LLP, 2001 ROSS AVENUE, 6TH FLOOR, DALLAS, TX, 75201-2980, US

(21) Appl. No.: 11/537,350

(22) Filed: Sep. 29, 2006

(51) Int. Cl. G06F 9/44

(52) U.S. Cl. 717/107; 717/106

(57) ABSTRACT

In a method embodiment, a method for controlling the release of data includes providing a list of a plurality of modules. Each module is operable to perform a task related to releasing data. The method further includes receiving a selection of an ordered set of the plurality of modules to use in a workflow. The workflow defines a procedure for releasing the data. The method also includes automatically generating a program implementing the workflow.

### TECHNICAL FIELD

This invention relates in general to the field of information technology and, in particular, to controlling the release of data within multi-level security systems.

### BACKGROUND

Most modern classified information systems include multi-level security. In general, multi-level security is the capability of a system to carry information with different sensitivities (i.e. classified information at different security levels), permit simultaneous access by users with different security clearances and needs-to-know, and prevent users from obtaining access to information for which they lack authorization. In many instances, transferring data between networks or systems of different classification levels involves examining the data to ensure it is permissible for release. Some data requires direct human inspection to determine whether the data is releasable. Managing the transfer of data within or between conventional multi-level security systems incorporating human review is costly and inefficient for a variety of reasons.

### SUMMARY OF THE EXAMPLE EMBODIMENTS

In a method embodiment, a method for controlling the release of data includes providing a list of a plurality of modules. Each module is operable to perform a task related to releasing data. The method further includes receiving a selection of an ordered set of the plurality of modules to use in a workflow. The workflow defines a procedure for releasing the data. The method also includes automatically generating a program implementing the workflow.

Technical advantages of some embodiments of the invention may include electronic automation of the review process that significantly reduces costs, while enhancing security, efficiency, configurability, and auditing associated with releasing data between security levels of a MLS systems. Some embodiments may inherently provide these advantages without any user-level interaction. In addition, technical advantages associated with a workflow-driven framework enables a review process that is highly configurable and expandable.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1A is a block diagram illustrating one embodiment of a portion of a classified information system having multi-level security;

FIG. 1B is a block diagram illustrating one embodiment of a review manager application for the classified information system of FIG. 1A;

FIG. 2 illustrates an embodiment of a portion of a graphical user interface (GUI) that may be used with the system of FIGS. 1A and 1B; and

FIG. 3 is a call flow diagram illustrating one embodiment of a method for controlling the release of data within the system of FIGS. 1A and 1B.

### DESCRIPTION OF EXAMPLE EMBODIMENTS

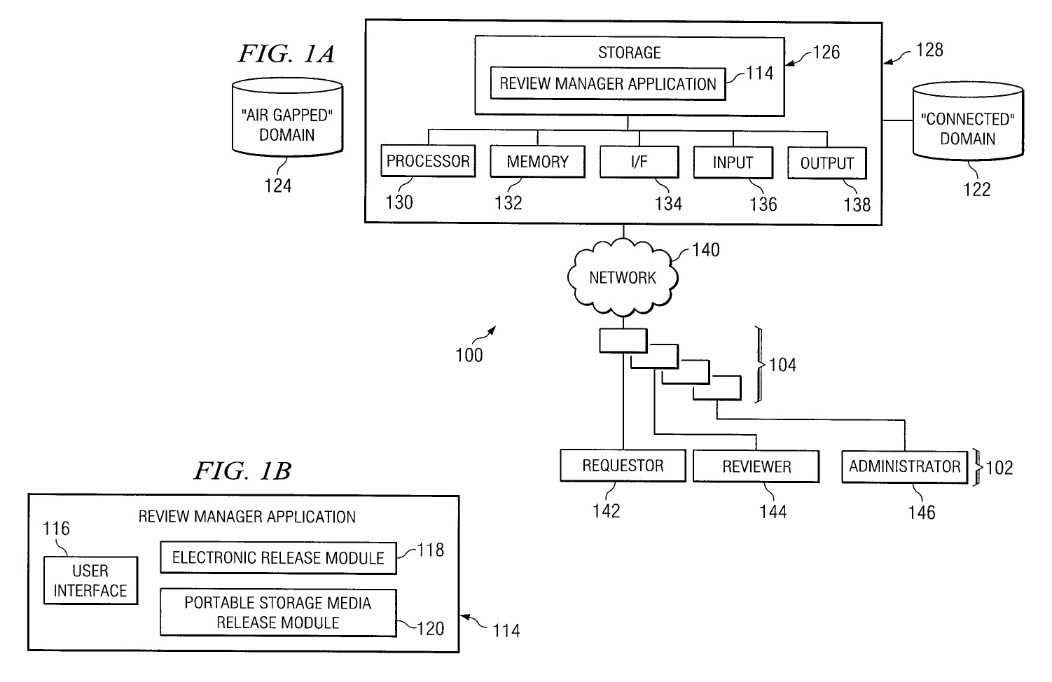

In accordance with the teachings of the present invention, a method and system for controlling the release of data are provided. Embodiments of the present invention and its advantages are best understood by referring to FIGS. 1A through 3 of the drawings, like numerals being used for like and corresponding parts of the various drawings. Particular examples specified throughout this document are intended for example purposes only, and are not intended to limit the scope of the present disclosure.

FIG. 1A is a block diagram illustrating one embodiment of a portion of a multi-level security system 100. System 100 generally includes a plurality of clients 104 associated with a server 128 through a network 140, a “connected” domain 122, and an “air gapped” domain 124. In addition, a review manager application 114 residing in storage 126 of server 128 is operable to automate, simplify, and manage controlling the release of data associated with multi-level security system 100.

Network 140 may refer to any interconnecting system capable of transmitting audio, video, signals, data, messages, or any combination of the preceding. Network 140 may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding. In particular embodiments of the invention, network 140 may transmit information in packet flows; however, information may alternatively be transferred without the use of packets. A packet flow includes one or more packets sent from a source to a destination. A packet may comprise a bundle of data organized in a specific way for transmission, and a frame may comprise the payload of one or more packets organized in a specific way for transmission. A packet-based communication protocol such as Internet Protocol (IP) may be used to communicate the packet flows.

Server 128 may include, for example, a file server, a domain name server, a proxy server, a web server, a computer workstation, or any other device operable to respond to requests for data from clients 104. Server 128 may execute with any of the well-known MS-DOS, PC-DOS, OS-2, MAC-OS, WINDOWS™, UNIX, or other appropriate operating systems, including future operating systems. Server 128 includes a processor 130, memory 132, a network interface 134, input functionality 136, and output functionality 136. In the illustrated embodiment, server 128 comprises one or more Apache Jakarta Tomcat web servers, which typically may run on either WINDOWS or UNIX platforms; however, server 128 may be any appropriate server type.

The “connected domain” 122 and “air gapped” domain 124 are operable to store data, and facilitate addition, modification, and retrieval of such data. The “connected” domain 122 includes one or more servers; however the “connected” domain 122 may utilize other data management systems. In the illustrated embodiment, the “connected” domain 122 resides separate from server 128. In other embodiments the “connected” domain 122 may reside within server 128. The “air gapped” domain 124 sends to, or receives data from, devices not networked or physically “connected” to sever 128. This may be effected by, for example, compact discs (CD), digital versatile discs (DVD), or any other type of removable media. Such data transfer may be to or from one level of a multi-level security system 100 to another, or out of system 100 altogether.

Clients 104 generally refer to any suitable device operable to communicate with server 128 through network 140. Clients 104 may execute with any of the well-known MS-DOS, PC-DOS, OS-2, MAC-OS, WINDOWS™, UNIX, or other appropriate operating systems, including future operating systems. Clients 104 may include, for example, a personal digital assistant, a computer such as a laptop, a cellular telephone, a mobile handset, or any other device operable to communicate with server 128 through network 140. In this particular embodiment, clients 104 generally enable the following groups of users 102 to communicate with server 128: requesters 142, reviewers 144, and administrators 146. The privileges associated with each user group 142, 144, and 146 are explained further below.

In operation of various embodiments of system 100, a requester 142 may communicate with review manager application 114 using a client 104 to initiate a data release request. In some instances, the data requested for release may be, for example, highly classified data stored on the “connected” domain 122 and/or the “air gapped” domain 124. Review manager application 114 may then alert the appropriate reviewers 144. In some instances, a reviewer may communicate with review manager application 114 using a client 104 to review, digitally sign, and release the highly classified data to a lower level of classification. The released data may then transfer to a desired destination.

For conventional multi-level security systems, the sharing of data between different classification or security levels is costly and inefficient for a variety of reasons. For example, conventional multi-level security systems fail to provide efficient, reliable mechanisms by which a Top Secret user can review, release, and then deliver a Top Secret file to users with Secret or lower clearances. Conventionally, the human review process is often either too informal, or involves very strict and burdensome paperwork. In addition, conventional human review processes rarely provide a strong audit trail. Most available technical safeguards are manual and fallible, if even used at all. Consequently, many conventional multi-level security systems process all or a majority of data within a Top Secret or “high” level environment, regardless of the true classification level of the data, thereby limiting crucial information sharing. Accordingly, teachings of some embodiments of the invention recognize that a review manager application 114 can provide electronic automation of the data review process associated with multi-level security systems 100. This automation may significantly reduce costs, while enhancing security, efficiency, configurability, and auditing capabilities. Some embodiments may inherently provide these advantages without any human interaction. For example, review manager application 114 may automatically incorporate technical safeguards, automated processing, auditing, event notification, and workflow management. As explained further below, the workflow-driven framework of review manager application 114 enables a review process that is highly configurable and expandable. In addition, review manager application 114 allows creation of new task-performing modules, while allowing the reuse of preexisting modules built into the review manager application 114 framework.

A better understanding of various aspects of the present invention may be had by making reference to FIGS. 1B, 2 and 3, which illustrate various aspects of the review manager application 114 of FIG. 1A in accordance with particular embodiments of the present invention.

FIG. 1B is a block diagram illustrating one embodiment of a portion of the multi-level security system 100 of FIG. 1A. As shown in FIG. 1B, the review manager application 114 generally includes a user interface 116, an electronic release process 118, and a portable storage media release process 120.

In the illustrated embodiment, the review manager application 114 generally includes a combination of front-end Java Server Pages and back-end Java servlets and utility classes. MySQL may be used as a back-end database for the web applications. Apache Jakarta Tomcat servers are appropriate hosts for review manager application 114. However, any appropriate hardware and software combination may be used without departing from the scope of the present disclosure.

In the illustrated embodiment, the review manager application 114 framework is workflow-driven. A workflow is an ordered list of modules, each module operable to perform a task related to controlling the release of data. As described in more detail below, execution of a workflow starts with the first module in the list. Upon completion of a module task, the active module calls the subsequent module in the ordered list using, for example, a defined API. When the final module finishes, the workflow is complete. In most instances, the final module performs the actual data transfer.

The workflows applied to release processes 118 and 120 typically have differing respective data sources and/or data transfer destinations. For example, the portable storage media release process 120 may involve uploading data from the “air gapped” domain 124 and/or recording releasable data onto portable data storage media such as CDs or DVDs. However, the electronic release process 118 typically involves uploading data by users of clients 104 through network 140 or through the “connected” domain 122 and transferring the files to the same. The workflows associated with both release processes 118 and 120 often involve some form of human review.

Workflows including human review modules may involve several steps. In general, a client 104 user submits data for review. The review manager application 114 then alerts one or more reviewers 144 responsible for that type of data. Each reviewer 144 claims responsibility and reviews the data to determine whether it is releasable. Additional processing may be automatically performed on the file. Finally, the releasable file is transferred to the desired destination.

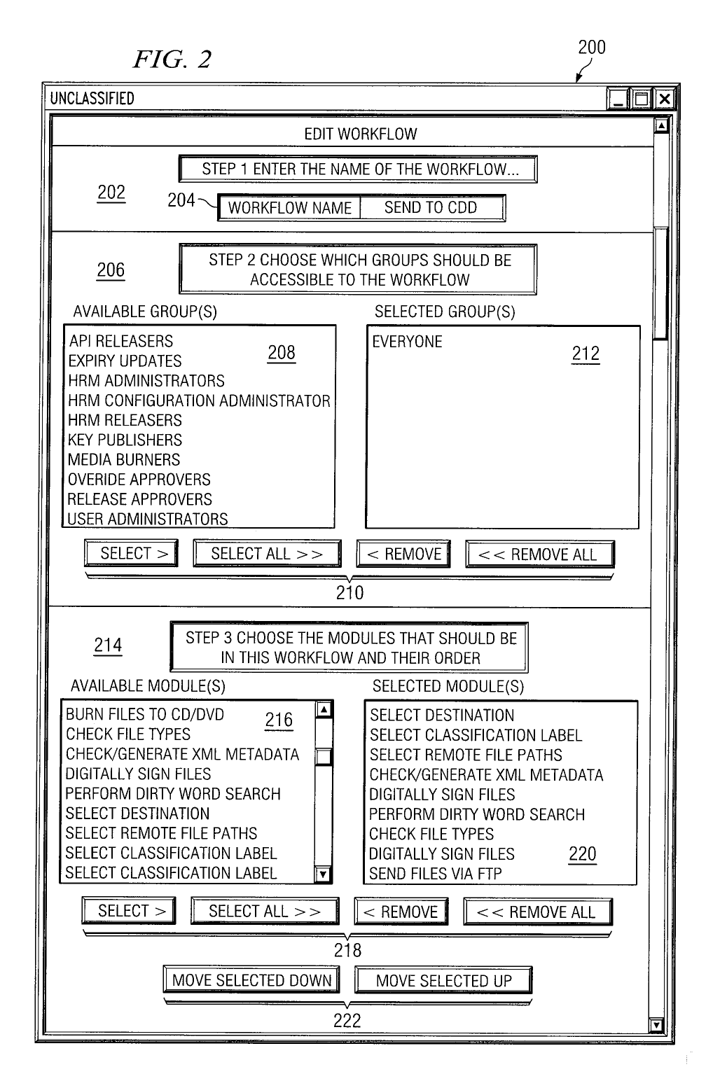

In this particular embodiment, user interface 116 is a web-based graphical user interface, as described further with reference to FIG. 2. Although this embodiment uses a web-based interface 116, in other embodiments interface 116 may be other than web-based. For example, other embodiments may use a JAVA API user interface in conjunction with, or in lieu of, the web-based interface 116. Interface 116 allows multiple users 102 of clients 104 to communicate with review manager application 114 at any given time. Review manager application 114 may prescribe specific privileges to individual user groups, including requesters 142, reviewers 144 and administrators 146.

Requestors 142 may perform request-related actions within system 100 using the web-based interface 116. For example, the request-related actions may include the following: creating a new data transfer request, deleting active requests, reverting a request to the pre-workflow or “uninitiated” state, merging two or more requests together, giving up “ownership” a request, taking “ownership” of request, reassigning a request, and providing information to a specific module.

A request is a container for one or more files that may be sent through a workflow. Requests may be in one of several states. Example states include the following: a request may be “unassigned,” in which case it may be claimed by any user 102; a request may be “uninitiated” if assigned, but without a designated workflow; a request may be “in progress” if currently processing one of the modules of a workflow; a request may be “in error” if one of the modules generated an error; and a request may be “complete” once the workflow is completed.

In the illustrated embodiment, requesters 142 may perform actions that automatically create a request such as, for example, uploading one or more files to the server from the “air gapped” domain 124 or choosing one or more files from within the “connected” domain 122. In addition, web-based interface 116 allows requesters 142 to review request-related information including, for example, the audit history of a request, the status of a request, the workflow associated with a request, and the current step within the workflow. As explained further below, in various embodiments, review manager application 114 may prompt requesters 142 to input a desired file transfer destination of the “air gapped” domain 124 or the “connected” domain 122.

In the illustrated embodiment, reviewers 144 are another group of users 102 that may participate in controlling the release of data within system 100 using review manager application 114. Reviewers 144 play a role in the data release process in that they approve data, including data files, of system 100 for release. Reviewers 144 may access review manager application 114 using the web-based interface 116. Reviewers 144 may receive notification, by email for example, when a new request is added or “assigned” to the release queue of a reviewer 144. As part of the release process, each assigned reviewer 144 is responsible for verifying that the file is releasable by independently reviewing the file. Thus, reviewers 144 provide a human factor to supplement the technical safeguards in review manager application 114. A file request may pass through multiple reviewers 144 to provide multiple acknowledgements. Part of this review process may include the application of a digital signature associated with each reviewer 144, indicating that the reviewer 144 has approved the file for release. In various embodiments, review manager application 114 may force reviewers 144 to review each of a plurality of files attached to a particular request before reviewers 114 are permitted to digitally sign and release the files. The digital signature may allow the file to pass through security interfaces within system 100, or between system 100 and other networks or systems.

In the illustrated embodiment, administrators 146 are another group of users 102 with special privileges. These privileges may include, for example, the ability to define and modify workflows, configure modules within a workflow, and configure global data used by modules. In addition, administrators 146 can change any particular request, even if not specifically assigned. For example, administrators 146 may perform the following actions for any requests: delete the request; “unassign” the request; revert the request to the “uninitiated” state; and view the audit history for the request. In addition, review manager application 114 may allow administrators 146 to view deleted requests, and add, modify, or disable users 102.

Thus, in this particular embodiment, requesters 142, reviewers 144, and administrators 146 each have specific privileges associated with review manager application 114 that enables these users 102 to participate in controlling the release of data of system 100. This control may include releasing data between different levels of a multi-level security system, after reviewers 144 have digitally signed the data and affixed the data with a security label using review manager application 114. In various embodiments, a graphical user interface 116 (“GUI”) may facilitate controlling the release of data of system 100, including configuring and expanding review manager application 114. An example GUI is illustrated in FIG. 2.

FIG. 2 is a screen shot illustrating one embodiment of a graphical user interface (“GUI”) 200 that may be used with the review manager application 114 of FIG. 1A. As illustrated in FIG. 2, GUI 200 provides a web-based interface 116 that enables a user 102 (e.g., requester 142, reviewer 144, and administrator 146) with appropriate privileges to create or edit a workflow within review manager application 114. As will be shown, review manager application 114 allows near total flexibility in defining workflows and associated modules in order to meet various needs. GUI 200 is generally divided into three sections: a workflow identification section 202, a group selection section 206, and a module selection section 214.

The workflow identification section 202 includes a text field 204 capable of accepting user 102 input that establishes a workflow identity. The group selection section 206 allows a user 102 to control accessibility to the workflow being edited. Group selection section 206 generally includes two select fields 208 and 212, and a group of control buttons 210. Select field 208 contains a list of available groups. Control buttons 210 enables a user 102 to configure a selected group(s) list that appears in select field 212. The selected group list in select field 212 is generally a subset of the available groups from select field 208, though some workflows may be configured to allow access to all users 102.

The module selection section 214 allows a user 102 to create an ordered list of modules for the workflow being edited. Module selection section 214 generally includes two select fields 216 and 220, and two groups of control buttons 218 and 222. Select field 216 contains a list of available modules. Control buttons 218 enables a user 102 to configure a selected module(s) list that appears in select field 220. Control buttons 222 allow a user 102 to configure the order of the selected modules within select field 220.

Each module in select field 216 available to any given workflow may perform any of a variety of tasks. For example, during implementation of a workflow, various modules may request the following information from a user 102: file identification for transfer, file destination, remote path destination, file transfer protocol, and classification level. Some modules may automatically perform actions, including the following examples: retrieving a file, checking the file type, generating data based on the file content, scanning the file content for highly classified or “dirty” words. Several modules require human performed tasks, such as, for example, reviewing and approving the file by the file owner and/or at least one member of the group of assigned reviewers 144, depending on the module configuration. The review process may incorporate modules that digitally sign and/or digitally mark the file as releasable. Some modules may be associated with electronically transferring the file or storing the file in a portable storage media, such as, for example, a CD or DVD, for physical transfer.

In some instances, the modules available in select field 216 may be interdependent according to a set of predetermined rules. For example, if a user 102 selects an electronic file transfer module, the workflow might also require a module associated with requesting a file destination. In various embodiments, review manager application 114 may automatically update or alter the workflow to incorporate any such interdependent modules. Some embodiments may alert the user 102 if a predetermined rule is violated and/or request input from the user 102 accordingly.

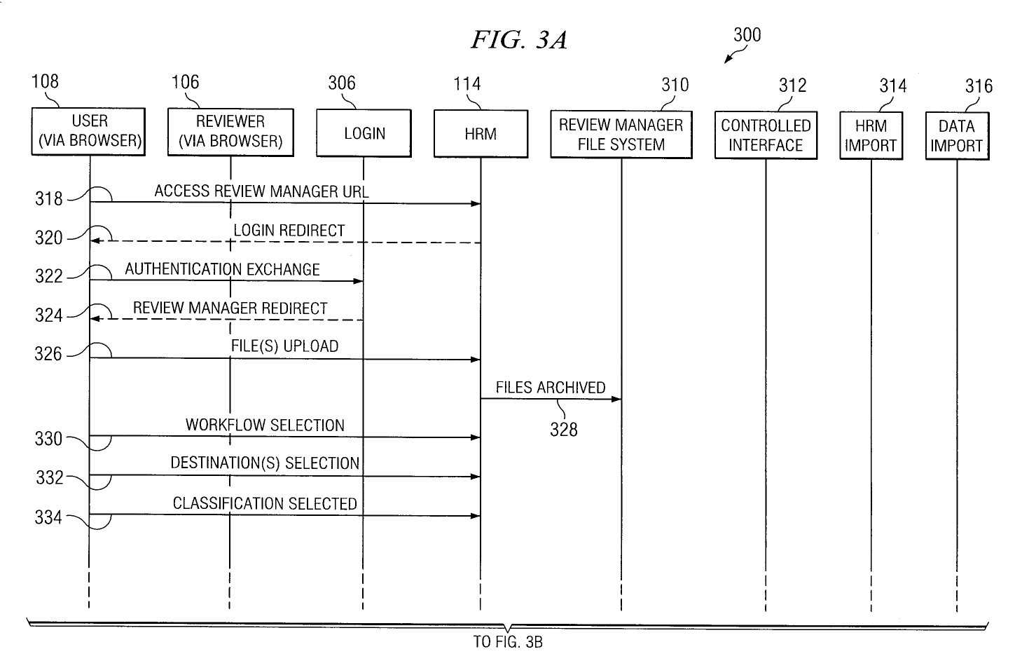

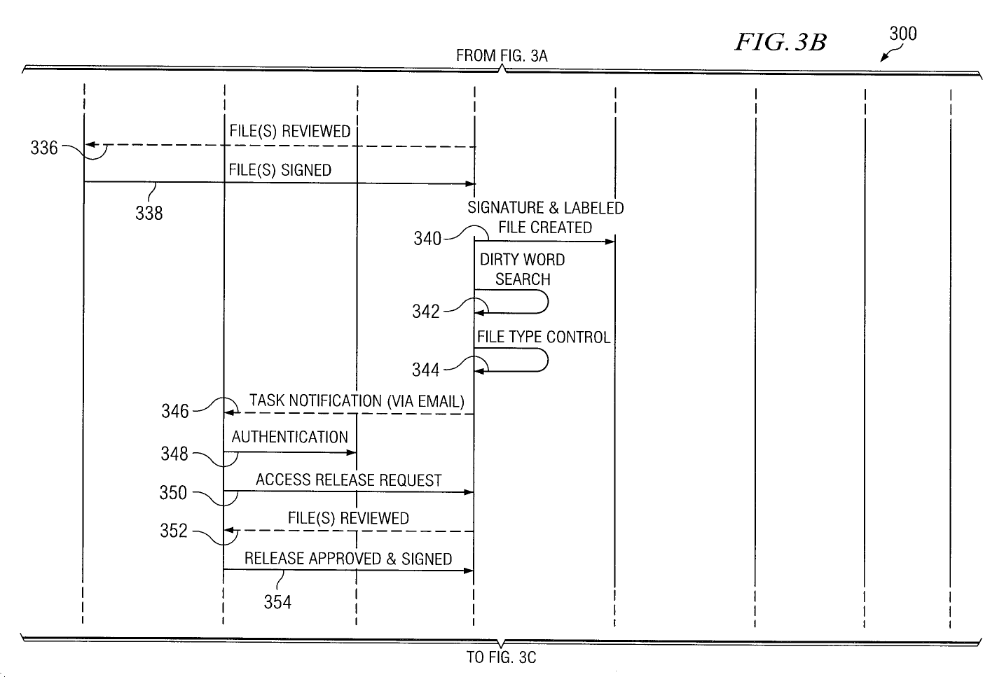

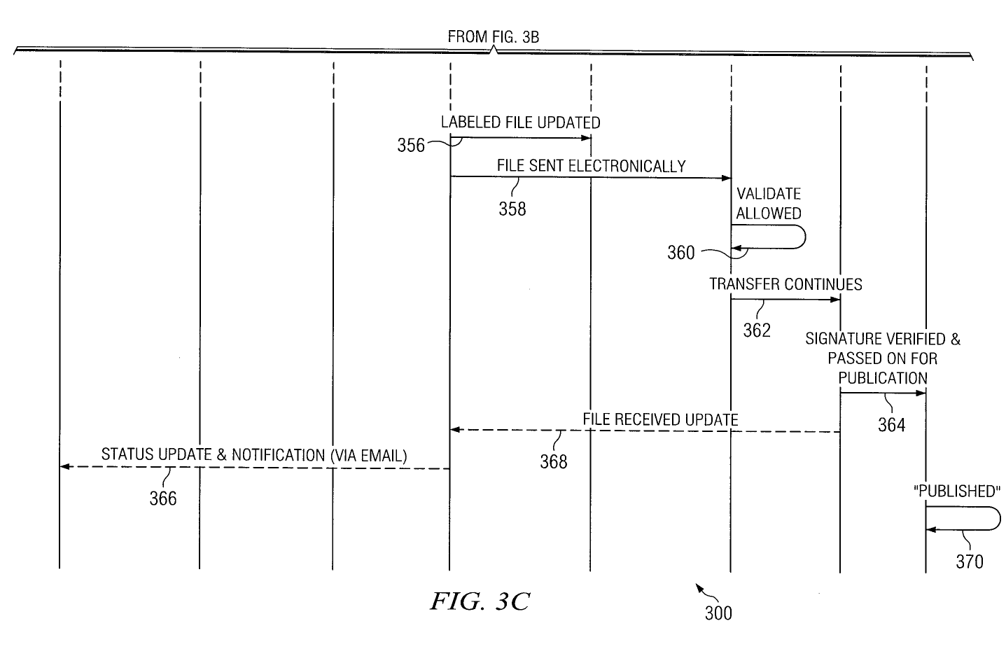

Review manager application 114 may include various other GUIs similar in structure and function to GUI 200. For example, various embodiments may include a GUI that permits a user 102 to create or modify new modules, thereby adding to the modules available to select field 216. In this particular embodiment, users 102 may access review manager application 114 through GUI 114 to request data release, review the data, and ultimately release data between levels of a multi-level security system, as described further with reference to FIG. 3.

FIG. 3 is a call flow diagram illustrating one embodiment of a method 300 for controlling the release of data within system 100 of FIG. 1A. Method 300 illustrates a simplified process in that it only involves a two-person review: a single requester 142 and single reviewer 144. The method begins at step 318, where the requester 142 accesses human review manager 114. Review manager application 114 may perform an authenticating procedure at steps 320-324 to authenticate requester 142.

Requestor 142 requests a file transfer by uploading a file at step 326. A review manager file system 310 archives the file at step 328. The requester 142 performs a series of selections at steps 330, 332, and 334, including workflow, destination, and classification level respectively. In this particular embodiment, the request involves a file transfer from a “high” to a “low” classification level. Review manager application 114 prompts requester 142 to review the file at step 336. Requestor 142 reviews and digitally signs the file at step 338.

Review manager application 114 then creates and stores an associated signature and label file in the review manager file system 310. In addition, review manager application 114 performs a “dirty” word or phrase search and any necessary automated controls associated with the file type at steps 342 and 344 respectively. Then review manager application 114 sends a task notification to reviewer 144 via email at step 346.

Reviewer 144 authenticates and accesses the release request at steps 348 and 350 respectively. At step 352, reviewer 144 reviews the file. After determining the file is releasable, reviewer 144 approves and digitally signs the file at step 354. The signature and label file in the review manager file system 310 is updated appropriately at step 356.

Review manager application 114 sends the requested file electronically to controlled interface 312 at step 358. In various embodiments, controlled interface 312 may be, for example, a firewall or a guard. Steps 360, 362, and 364 validate that the file is releasable and verify authenticity of the digital signature. Data import 316 on the recipient end then publishes the file at step 370. Human review manager import 314 transfers the file to an FTP server, which returns the appropriate error message or transfer complete message after attempting to transfer the file. If the file was successfully received, human review manager import 314 alerts review manager application 114 at step 368. Review manager application 114 then sends a status update and notification to requester 142 at step 366. The process then terminates.

Although this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for controlling the release of data comprising:
providing a list of a plurality of modules each operable to perform a task related to releasing data;
receiving a selection of an ordered set of the plurality of modules to use in a workflow that defines a procedure for releasing the data; and
automatically generating a program implementing the workflow.

2. The method of claim 1, wherein the method is implemented by an application having one or more web-based modules.

3. The method of claim 1, and further comprising providing a graphical user interface screen comprising:
a text field capable of identifying the workflow;
a first select field capable of accepting user input related to accessibility of the workflow; and
a second select field capable of accepting user input related to receiving a selection from the list of an ordered set of the modules to use in a workflow.

4. The method of claim 1, and further comprising evaluating the ordered set of the plurality of modules under a set of predetermined rules.

5. The method of claim 4, and further comprising alerting a user if at least one rule of the set of predetermined rules is violated.

6. The method of claim 4, and further comprising automatically modifying the selection of an ordered set of the plurality of modules to comply with the set of predetermined rules.

7. The method of claim 1, and further comprising editing the configuration of at least one of the modules in the list of a plurality of modules.

8. The method of claim 1, and further comprising editing global data used by at least one of the modules in the list of a plurality of modules.

9. The method of claim 1, wherein providing a list of a plurality of modules comprises generating new modules operable to perform a task related to releasing data.

10. The method of claim 1, wherein releasing the data comprises releasing the data from a first security level to a second security level of a multi-level security system.

11. The method of claim 1, wherein implementing the workflow comprises manually reviewing the data.

12. The method of claim 1, wherein providing a list of a plurality of modules comprises providing a plurality of modules selected from the group consisting of:
requesting at least one file to transfer;
retrieving the at least one file;
selecting a destination;
selecting a remote file path;
selecting a file transfer protocol;
selecting a classification level;
scanning for dirty words;
checking the file type;
generating data;
checking data;
assigning the file to at least one file owner;
assigning the file to at least one group comprised of at least one group member;
reviewing the at least one file;
approving the file by the at least one file owner;
approving the file by at least one member of the group;
digitally signing the at least one file;
digitally marking the at least one file as releasable;
checking the file for releasability;
storing the file in a portable storage media; and
transferring the at least one file.

13. A system for controlling the release of data comprising:
a review manager application operable to:
provide a list of a plurality of modules each operable to perform a task related to releasing data;
receive a selection of an ordered set of the plurality of modules to use in a workflow that defines a procedure for releasing the data; and
automatically generate a program implementing the workflow.

14. The system of claim 13, wherein the review manager application comprises one or more web-based modules.

15. The system of claim 13, wherein the review manager application further comprises a graphical user interface screen comprising:
a text field capable of identifying the workflow;
a first select field capable of accepting user input related to accessibility of the workflow; and
a second select field capable of accepting user input related to receiving a selection from the list of an ordered set of the modules to use in a workflow.

16. The system of claim 13, wherein the workflow defines a procedure for releasing the data from a first security level to a second security level of a multi-level security system.

17. Logic encoded in media, the logic being operable to:
provide a list of a plurality of modules each operable to perform a task related to releasing data;
receive a selection of an ordered set of the plurality of modules to use in a workflow that defines a procedure for releasing the data; and
automatically generate a program implementing the workflow.

18. The logic of claim 17, wherein the logic comprises one or more web-based modules.

19. The logic of claim 17, wherein the logic further comprises a graphical user interface screen comprising:
a text field capable of identifying the workflow;
a first select field capable of accepting user input related to accessibility of the workflow; and
a second select field capable of accepting user input related to receiving a selection from the list of an ordered set of the modules to use in a workflow.

20. The logic of claim 17, wherein the logic is operable to release the data from a first security level to a second security level of a multi-level security system.
